(19) United States
(12) Patent Application Publication
(10) Pub. No.: US 2012/0011529 A1
(43) Pub. Date: Jan. 12, 2012

(54) SYSTEM AND METHOD TO DETERMINE VIEWERSHIP

(75) Inventors: JERALD R. HOWCROFT, Beverly Hills, MI (US); WILLIAM R. HURST, San Antonio, TX (US); DAVID A. LEVINE, Smyrna, GA (US)

(73) Assignee: AT&T INTELLECTUAL PROPERTY I, L.P., Reno, NV (US)

(21) Appl. No.: 12/831,894

(22) Filed: Jul. 7, 2010

(51) Int. Cl. H04H 60/32

(52) U.S. Cl. 725/14

(57) ABSTRACT

A system that incorporates teachings of the present disclosure may include, for example, network device having a controller programmed to track a number of times that a particular service channel is distributed to a subscriber device from at least a network device selected from the group of a unicast stream server, a multicast stream router, or a digital subscriber line access multiplexer (DSLAM) which is used in an Internet Protocol Television (IPTV) network when the subscriber device is initially tuned to the particular service channel and to obtain real time viewership information by polling the network device in the IPTV network to determine how many subscriber devices are tuned to each service channel in the IPTV network. Other embodiments are disclosed.

### FIELD OF THE DISCLOSURE

The present disclosure relates generally to communication systems and more specifically to a system and method to determine viewership.

### BACKGROUND

Interactive TV networks provide a multitude of services including broadcast programming and video-on-demand. These networks reach out to users in various environments including single family residences, multi-dwelling apartments and commercial facilities. The types of service and the ability to provide those services is often dependent on the particular environment of the potential users. Furthermore, real time information that is accurate is difficult to determine from an interactive TV network.

### BRIEF DESCRIPTION OF THE DRAWINGS

FIGS. 1, 4, and 5 depict illustrative embodiments of communication systems that provide program retrieval services;

FIG. 2 depicts an illustrative embodiment of a portal interacting with the communication system of FIG. 1;

FIG. 3 depicts an illustrative embodiment of a communication device utilized in the communication system of FIG. 1;

FIG. 6 depicts an illustrative embodiment of a method operating in portions of the communications systems of FIGS. 1, 4 and 5;

FIG. 7 is a diagrammatic representation of a machine in the form of a computer system within which a set of instructions, when executed, may cause the machine to perform any one or more of the methodologies discussed herein.

### DETAILED DESCRIPTION

One embodiment of the present disclosure can entail a non-transitory computer readable storage medium comprising computer instructions to track a number of times that a particular television channel is burst to a subscriber from at least a unicast stream server that is used in an Internet Protocol Television (IPTV) network when the subscriber initially tunes to the particular television channel. The computer instructions can also obtain real time viewership information by polling the unicast stream server in the IPTV network to determine how many set top boxes (STBs) are tuned to each television channel in the IPTV network.

Another embodiment of the present disclosure can entail a method comprising tracking a number of times that a particular service channel is distributed to a subscriber from at least a network device that is used in an Internet Protocol IPTV network when the subscriber initially tunes to the particular service channel and retrieving real time viewership information by polling the network device in the IPTV network to determine how many set top boxes (STBs) are tuned to each stream.

Yet another embodiment of the present disclosure can entail a network device comprising a controller programmed to track a number of times that a particular service channel is distributed to a subscriber from at least a network device selected from the group of a unicast stream server, a multicast stream router, or a digital subscriber line access multiplexer (DSLAM) which is used in an Internet Protocol Television (IPTV) network when a subscriber initially tunes to the particular service channel. The controller can also be programmed to obtain real time viewership information by polling the network device in the IPTV network to determine how many presentation devices are tuned to each service channel in the IPTV network.

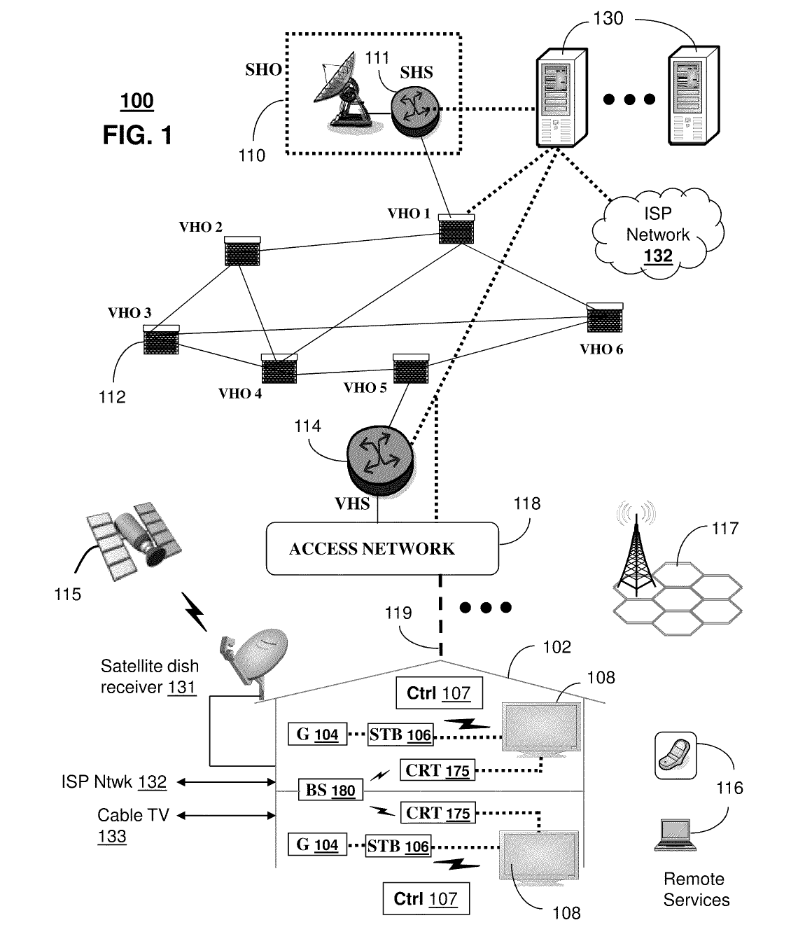

FIG. 1 depicts an illustrative embodiment of a first communication system 100 for delivering media content. The communication system 100 can represent an Internet Protocol Television (IPTV) broadcast media system. The IPTV media system can include a super head-end office (SHO) 110 with at least one super headend office server (SHS) 111 which receives media content from satellite and/or terrestrial communication systems. In the present context, media content can represent audio content, moving image content such as videos, still image content, or combinations thereof. The SHS server 111 can forward packets associated with the media content to video head-end servers (VHS) 114 via a network of video head-end offices (VHO) 112 according to a common multicast communication protocol.

The VHS 114 can distribute multimedia broadcast programs via an access network 118 to commercial and/or residential buildings 102 housing a gateway 104 (such as a common residential or commercial gateway). The building 102 can be various types including multi-dwelling units which house a plurality of different subscribers. The access network 118 can represent a group of digital subscriber line access multiplexers (DSLAMs) located in a central office or a service area interface that provide broadband services over optical links or copper twisted pairs 119 to buildings 102. The gateway 104 can use common communication technology to distribute broadcast signals to media processors 106 such as Set-Top Boxes (STBs) which in turn present broadcast channels to media devices 108 such as computers or television sets managed in some instances by a media controller 107 (such as an infrared or RF remote control).

The gateway 104, the media processors 106, and media devices 108 can utilize tethered interface technologies (such as coaxial or phone line wiring) or can operate over a common wireless access protocol. With these interfaces, unicast communications can be invoked between the media processors 106 and subsystems of the IPTV media system for services such as video-on-demand (VoD), browsing an electronic programming guide (EPG), or other infrastructure services.

Some of the network elements of the IPTV media system can be coupled to one or more computing devices 130 a portion of which can operate as a web server for providing portal services over an Internet Service Provider (ISP) network 132 to wireline media devices 108 or wireless communication devices 116 by way of a wireless access base station 117 operating according to common wireless access protocols such as Wireless Fidelity (WiFi), or cellular communication technologies (such as GSM, CDMA, UMTS, WiMAX, Software Defined Radio or SDR, and so on).

Another distinct portion of the computing devices 130 can function as a server (herein referred to as server 130). The server 130 can use common computing and communication technology to perform the function of relaying and/or receiving media content to ISP network 132 or to other networks.

It will be appreciated by an artisan of ordinary skill in the art that a satellite broadcast television system can be used in place of the IPTV media system. In this embodiment, signals transmitted by a satellite 115 supplying media content can be intercepted by a common satellite dish receiver 131 coupled to the building 102. Modulated signals intercepted by the satellite dish receiver 131 can be submitted to the media processors 106 for generating broadcast channels which can be presented at the media devices 108. The media processors 106 can be equipped with a broadband port to the ISP network 132 to enable infrastructure services such as VoD and EPG described above.

In yet another embodiment, an analog or digital broadcast distribution system such as cable TV system 133 can be used in place of the IPTV media system described above. In this embodiment the cable TV system 133 can provide Internet, telephony, and interactive media services.

In one embodiment, the building 102 can have a surveillance system 150 including various security devices such as security cameras, motion detectors, automated door locks, intercoms, processors and so forth. Each of the units and/or subscribers within the building 102 can have a cognitive radio transceiver (CRT) 175 that can wirelessly receive signals from the surveillance system 150. The signals can be video media captured by security cameras throughout the building (such as at the front door, the pool, and so forth).

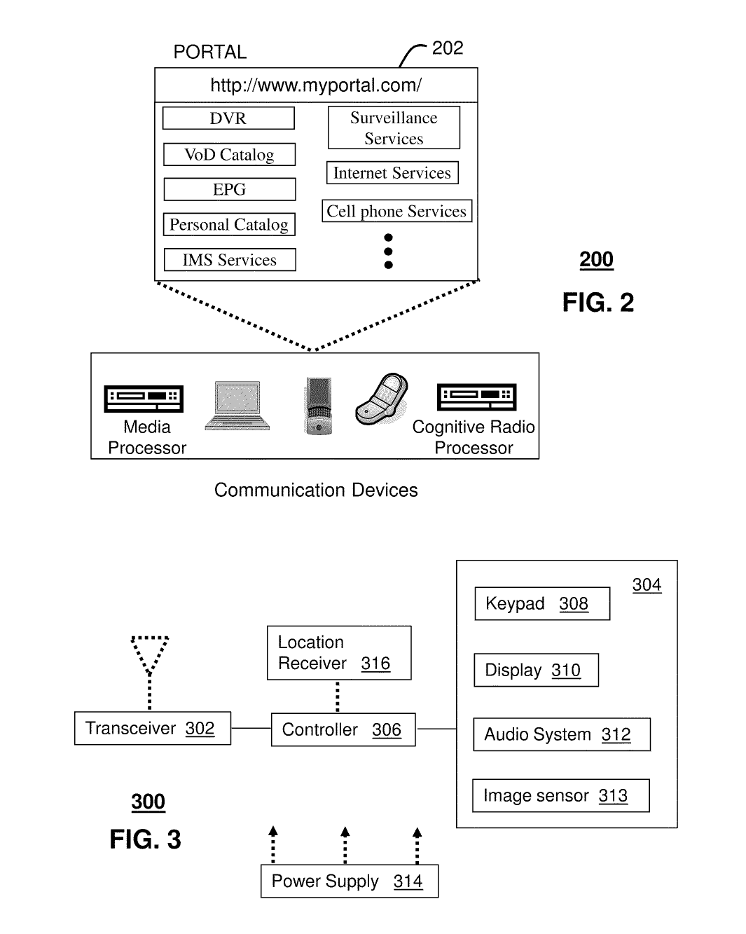

FIG. 2 depicts an illustrative embodiment of a portal 202 which can operate from the computing devices 130 described earlier of communication system 100 illustrated in FIG. 1. The portal 202 can be used for managing services of communication system 100. The portal 202 can be accessed by a Uniform Resource Locator (URL) with a common Internet browser such as Microsoft's Internet Explorer™ using an Internet-capable communication device such as those described for FIG. 1. The portal 202 can be configured, for example, to access a media processor 106 and services managed thereby such as a Digital Video Recorder (DVR), a VoD catalog, an EPG, a personal catalog (such as personal videos, pictures, audio recordings, etc.) stored in the media processor, provisioning IMS services, provisioning Internet services, provisioning cellular phone services, provisioning surveillance services and so on. For example, a user can utilize the portal to configure the cognitive radio processor for receiving video security footage as it is captured by security cameras in the building. In another embodiment, the captured video can be forwarded to other communication devices and/or entities, such as a mobile telephone of the user or the police.

FIG. 3 depicts an exemplary embodiment of a communication device 300. Communication device 300 can serve in whole or in part as an illustrative embodiment of the communication devices of FIG. 1. The communication device 300 can comprise a wireline and/or wireless transceiver 302 (herein transceiver 302), a user interface (UI) 304, a power supply 314, a location receiver 316, and a controller 306 for managing operations thereof. The transceiver 302 can support short-range or long-range wireless access technologies such as Bluetooth, WiFi, Digital Enhanced Cordless Telecommunications (DECT), or cellular communication technologies, just to mention a few. Cellular technologies can include, for example, CDMA-1X, UMTS/HSDPA, GSM/GPRS, TDMA/EDGE, EV/DO, WiMAX, SDR, and next generation cellular wireless communication technologies as they arise. The transceiver 302 can also be adapted to support circuit-switched wireline access technologies (such as PSTN), packet-switched wireline access technologies (such as TCPIP, VoIP, etc.), and combinations thereof.

The UI 304 can include a depressible or touch-sensitive keypad 308 with a navigation mechanism such as a roller ball, joystick, mouse, or navigation disk for manipulating operations of the communication device 300. The keypad 308 can be an integral part of a housing assembly of the communication device 300 or an independent device operably coupled thereto by a tethered wireline interface (such as a USB cable) or a wireless interface supporting for example Bluetooth. The keypad 308 can represent a numeric dialing keypad commonly used by phones, and/or a Qwerty keypad with alphanumeric keys. The UI 304 can further include a display 310 such as monochrome or color LCD (Liquid Crystal Display), OLED (Organic Light Emitting Diode) or other suitable display technology for conveying images to an end user of the communication device 300. In an embodiment where the display 310 is touch-sensitive, a portion or all of the keypad 308 can be presented by way of the display.

The UI 304 can also include an audio system 312 that utilizes common audio technology for conveying low volume audio (such as audio heard only in the proximity of a human ear) and high volume audio (such as speakerphone for hands free operation). The audio system 312 can further include a microphone for receiving audible signals of an end user. The audio system 312 can also be used for voice recognition applications. The UI 304 can further include an image sensor 313 such as a charged coupled device (CCD) camera for capturing still or moving images.

The power supply 314 can utilize common power management technologies such as replaceable and rechargeable batteries, supply regulation technologies, and charging system technologies for supplying energy to the components of the communication device 300 to facilitate long-range or short-range portable applications. The location receiver 316 can utilize common location technology such as a global positioning system (GPS) receiver for identifying a location of the communication device 300 based on signals generated by a constellation of GPS satellites, thereby facilitating common location services such as navigation.

The communication device 300 can use the transceiver 302 to also determine a proximity to a cellular, WiFi or Bluetooth access point by common power sensing techniques such as utilizing a received signal strength indicator (RSSI) and/or a signal time of arrival (TOA) or time of flight (TOF). The controller 306 can utilize computing technologies such as a microprocessor, a digital signal processor (DSP), and/or a video processor with associated storage memory such a Flash, ROM, RAM, SRAM, DRAM or other storage technologies.

The communication device 300 can be adapted to perform the functions of the media processor 106, the media devices 108, or the portable communication devices 116 of FIG. 1. It will be appreciated that the communication device 300 can also represent other common devices that can operate in communication system 100 of FIG. 1 such as a gaming console and a media player.

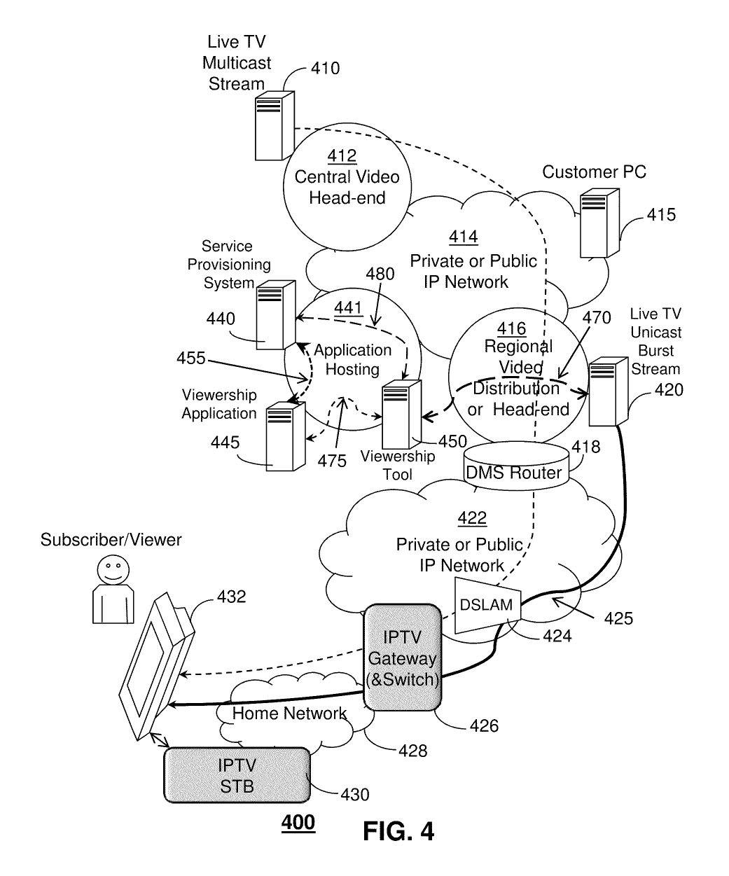

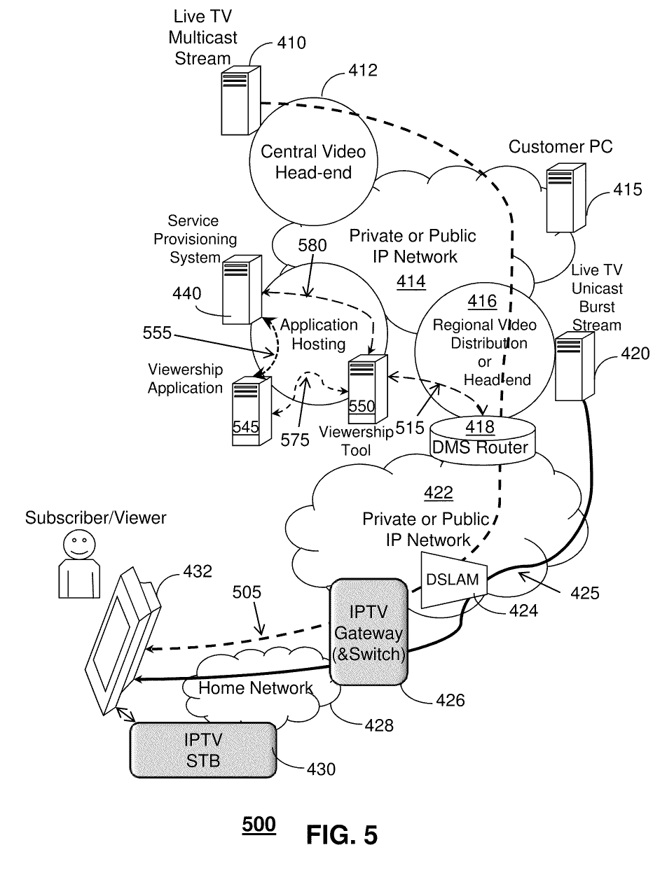

FIGS. 4 and 5 depict illustrative embodiments of a system 400 and another system 500 for enabling a subscriber to view (or listen) in real-time to a list of the most popular live shows other IPTV subscribers are currently watching or listening. To the inventor's knowledge, there is currently no built-in or native way to obtain the current real-time viewership information from existing IPTV systems. Although systems 400 and 500 outline two different solutions for obtaining such viewership information, it should be understood that there can be any number of additional systems within contemplation of the claimed embodiments as represented by the appended claims. Although the application is initially being developed for the TV, applications can also be expanded to the PC and Mobile devices.

The list of most popular shows can be sorted against the TV viewer's favorite channels list, or could be sorted into other categories such as sports, premium channels, or HD channels. The list can also be sorted against the channels the customer is subscribed to, in order to show the customer which shows he or she has access to and which shows would require a TV subscription upgrade.

The embodiments herein can also address how to scale within an IPTV system by prioritizing the commands (by placing viewership requests at a lower or lowest priority) used to obtain the viewership information, and by polling a subset of the entire IPTV subscriber base (typically within a region) in order to get an accurate sampling of the information that can be extrapolated to the entire customer base.

Systems 400 and 500 in FIGS. 4 and 5 respectively include a viewership application 445 with the flows for the customer or subscriber to access the application from a PC or a TV (or alternatively a cell phone). In the context of this Application, a subscriber device can any devices among a set top box, a personal video recorder, a cellular phone, a personal computer or a laptop computer or any combination thereof. The subscriber accesses the application and then navigates the application screens to request the viewership application which can be termed a “What's Hot Now” application. The system 400 or 500 can then display a real-time list of the most popular shows currently being viewed (where each entry can include absolute/relative viewership numbers).

System 400 of FIG. 4 illustrates the flows for obtaining real-time viewership information from a unicast stream server 420 that is used in the IPTV system 400 to burst the TV channel to the subscriber when they initially tune to the channel. This is used for instant channel change. System 400 as illustrated can be only a portion of an entire system having multiple VHOs, networks, servers, gateways, PCs (415) and STBs as discussed with respect to FIG. 1. Only certain portions are illustrated for simplicity. System 400 can also include a live multicast stream server 410 coupled through a central VHO 412, networks 414 and 422 through a regional video distribution or head-end 416 and router 418 as well as a DSLAM 424, IPTV gateway & switch 426. The IPTV signal or stream can ultimately reach the subscriber via a home network 428, an STB 430 and display 432.

A tool such as a viewership tool application 450 can be deployed (at an application hosting server or servers 441) that can poll the Unicast Burst Stream Server 420 (470) to request information regarding how many STB's (such as STB 430) are tuned to each service (a service is a channel, and the number of viewers tuned to the service is the number of unicasts). The polling of the Unicast Burst Stream Server 420 could occur at pre-defined periods of time, e.g., one minute after every half hour and one minute after the hour. The polling of the Unicast Burst Stream Server 420 could also be adjusted depending on the occasion (special events or shows that start at times not coinciding with the half hour or the hour). Since the Burst server 420 has to serve up a unicast stream 425 each time a channel is tuned, it knows how many streams are being provided to the viewers of the system. The tool application 450 can also poll (see dashed line 480) other backend systems (such as a service provisioning system 440) to obtain information to map the unicast stream information to the IPTV system's channel and geographic information.

The tool 450 can feed this information to the What's Hot Now application 445 (see dashed line 475) so it can be sorted and displayed to the customer. The What's Hot Now application 445 also discovers the customers Electronic Program Guide (EPG) or channel subscription information, either by polling a backend service provisioning system (shown by dashed line 455) or by asking the STB 430 for the viewers specific EPG. The commands issued on the Burst server to obtain the viewership information, based on the unicast stream information, can be set to the lowest priority so that they do not interrupt live TV viewing. The Tool 450 used to poll the Burst server 420 for the unicast information can also be configured to only poll a subset of Burst servers in order to obtain a statistically-accurate sampling of information, per geography or overall, in order to estimate the viewership with a statistical high degree of accuracy.

System 500 of FIG. 5 is similar to system 400 of FIG. 4, but more clearly illustrates flows for obtaining the real-time viewership information from the multicast stream router 418 that is used in the IPTV system to send the TV channel to the customer (thru stream 505) after the subscriber initially tunes to the channel and can get subscribed to the multicast stream. A tool 550 can be deployed that can poll the Distributed Multicast Stream router (see dashed line 515) at defined intervals of times (e.g., one minute after each half-hour and one minute after each hour) to request information regarding how many STB's are tuned to each multicast stream (505).

The tool 550 also can poll (see dashed line 580) other backend systems (such as service provisioning system 440) to obtain information to map the multicast stream information (IP address) to the IPTV systems channel (call letters) and geographic information (VHO membership). The tool 550 can feed (see dashed line 575) this information to the What's Hot Now application 545 so it can be sorted and displayed to the customer. The What's Hot Now application 545 can also discover the customers EPG or channel subscription information, either by polling a backend service provisioning system (see dashed line 555) or by asking the STB for the viewers specific EPG. As in the unicast based solution discussed above, the commands issued on the multicast router 418 to obtain the viewership information, based on the multicast stream information, can be set to the lowest priority so that they do not interrupt Live TV viewing. The Tool 550 used to poll the Distributed Multicast router 418 for the multicast information can be configured to only poll a subset of Distributed Multicast routers (418) in order to obtain a statistically-accurate sampling of information, per geography or overall, in order to estimate the viewership with a statistical high degree of accuracy. Alternatively the IPTV DSLAM 424 can be queried for the multicast information.

The Table below illustrates a sample command to a DSLAM in an IPTV system, to obtain the multicast information:

OLTIKSDN---01CAB101A
last login: 23/02/70 21:00:02
leg:isadmin># show mcast grp-membership
grp-membership table

| mcast-grp-addr \|vlan-id\|mcast-src-addr \|port | | | | \|state |
|---|---|---|---|---|
| 239.192.3.22 | 4000 | 0.0.0.0 | 1/1/7/3 | full-view |
| 239.192.3.27 | 4000 | 0.0.0.0 | 1/1/4/2 | full-view |
| 239.192.3.27 | 4000 | 0.0.0.0 | 1/1/4/9 | full-view |
| 239.192.3.27 | 4000 | 0.0.0.0 | 1/1/4/10 | full-view |
| 239.192.3.27 | 4000 | 0.0.0.0 | 1/1/4/11 | full-view |
| 239.192.3.27 | 4000 | 0.0.0.0 | 1/1/4/13 | full-view |
| 239.192.3.27 | 4000 | 0.0.0.0 | 1/1/5/27 | full-view |
| 239.192.3.27 | 4000 | 0.0.0.0 | 1/1/5/45 | full-view |
| 239.192.3.27 | 4000 | 0.0.0.0 | 1/1/5/46 | full-view |
| 239.192.3.27 | 4000 | 0.0.0.0 | 1/1/6/21 | full-view |
| 239.192.3.27 | 4000 | 0.0.0.0 | 1/1/7/3 | full-view |

grp-membership count: 11

The systems described above using a multicast stream, a unicast burst stream or the DSLAM can be used to obtain real-time viewership information with a high level of accuracy. Such embodiments can address scaling concerns of the system which can vary in scope and deployment from system to system or based on geographic or demographic configurations. The embodiments give the viewer popular choices of what to watch, in order to enhance their TV service experience and the viewership information can be used for many other applications or for other marketing purposes in a similar way that Neilson ratings are used.

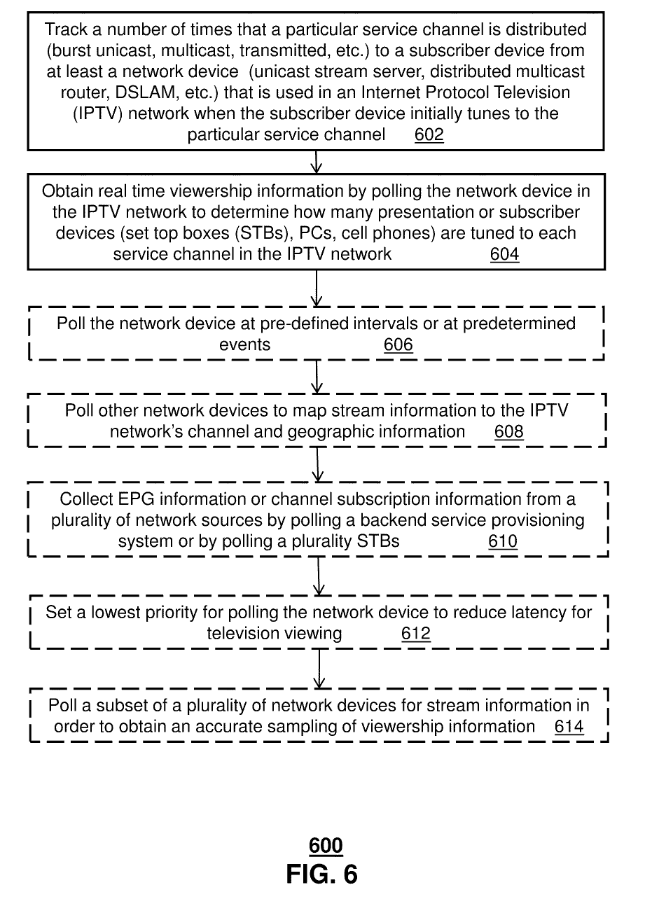

FIG. 6 depicts an illustrative method 600 that operates in portions of the communication systems of FIGS. 1, 4, and 5. Method 600 can begin with step 602 in which the method at 602 tracks the number of times that a particular service channel is distributed (burst unicast, multicast, etc.) to a subscriber from at least a network device (unicast stream server, distributed multicast router, DSLAM, etc.) that is used in an Internet Protocol Television (IPTV) network when the subscriber initially tunes to the particular service channel. At 604, the method 600 can obtain real time viewership information by polling the network device in the IPTV network to determine how many presentation devices (STBs, PCs, cell phones) are tuned to each service channel in the IPTV network. The method 600 optionally polls the network device at pre-defined intervals or at predetermined events at 606 and at 608 can further poll other network devices to map stream information to the IPTV network's channel and geographic information. At 610, the method can collect EPG information or channel subscription information from a plurality of network sources by polling a backend service provisioning system or by polling a plurality of STBs. At 612, the method can set a lowest priority for polling the network device to reduce latency for television viewing. Other means for reducing latency for television viewing can also be employed. For example, at 614, the system can poll a subset of a plurality of network devices for stream information in order to obtain an accurate sampling of viewership information.

Upon reviewing the aforementioned embodiments, it would be evident to an artisan with ordinary skill in the art that said embodiments can be modified, reduced, or enhanced without departing from the scope and spirit of the claims described below. For example, such a system and method can entail in a particular embodiment an STB or server which can ultimately track and provide viewership information based on streams sent to STBs, personal computers or mobile wireless devices such as cellular phone in a similar fashion as discussed above where the IPTV system is coupled to a wireless network and remote devices as illustrated in FIG. 1.

Other suitable modifications can be applied to the present disclosure without departing from the scope of the claims below. Accordingly, the reader is directed to the claims section for a fuller understanding of the breadth and scope of the present disclosure.

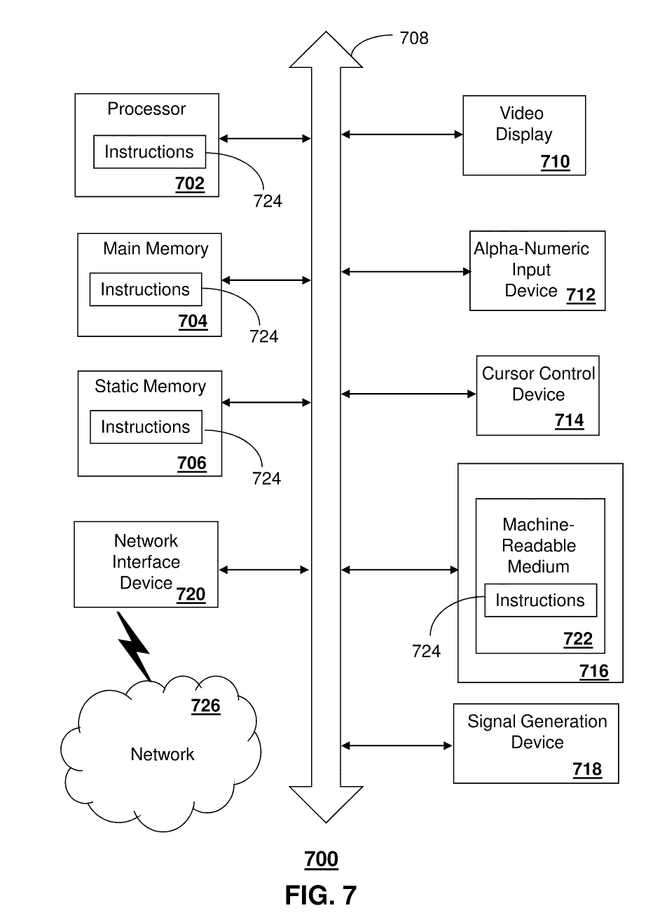

FIG. 7 depicts an exemplary diagrammatic representation of a machine in the form of a computer system 700 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 700 may include a processor 702 (e.g., a central processing unit (CPU), a graphics processing unit (GPU, or both), a main memory 704 and a static memory 706, which communicate with each other via a bus 708. The computer system 700 may further include a video display unit 710 (e.g., a liquid crystal display (LCD), a flat panel, a solid state display, or a cathode ray tube (CRT)). The computer system 700 may include an input device 712 (e.g., a keyboard), a cursor control device 714 (e.g., a mouse), a disk drive unit 716, a signal generation device 718 (e.g., a speaker or remote control) and a network interface device 720.

The disk drive unit 716 may include a machine-readable medium 722 on which is stored one or more sets of instructions (e.g., software 724) embodying any one or more of the methodologies or functions described herein, including those methods illustrated above. The instructions 724 may also reside, completely or at least partially, within the main memory 704, the static memory 706, and/or within the processor 702 during execution thereof by the computer system 700. The main memory 704 and the processor 702 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 724, or that which receives and executes instructions 724 from a propagated signal so that a device connected to a network environment 726 can send or receive voice, video or data, and to communicate over the network 726 using the instructions 724. The instructions 724 may further be transmitted or received over a network 726 via the network interface device 720.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/TP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A non-transitory computer readable storage medium comprising computer instructions to:
track a number of times that broadcast data associated with a particular television channel is transmitted to a set-top box (STB) by at least one unicast stream server that is used in an Internet Protocol Television (IPTV) network when the STB is tuned to the particular television channel; and
obtain real time viewership information by polling the unicast stream server in the IPTV network to determine how many set top boxes (STBs) are tuned to each television channel in the IPTV network.

2. The storage medium of claim 1, wherein the polling of the unicast stream server occurs at pre-defined intervals.

3. The storage medium of claim 1, wherein the polling of the unicast stream server occurs during a pre-determined event.

4. The storage medium of claim 1, wherein the method polls other network devices to map unicast stream information to the IPTV network's channel and geographic information.

5. The storage medium of claim 1, wherein the method sorts and presents information regarding viewership for a plurality of channels on the IPTV network.

6. The storage medium of claim 1, comprising computer instructions for collecting EPG information or channel subscription information from a plurality of network sources by polling a backend service provisioning system or by polling a plurality STBs on the IPTV network.

7. The storage medium of claim 1, comprising computer instructions to set a lowest priority for polling the unicast stream server to reduce latency for television viewing.

8. The storage medium of claim 1, comprising computer instructions to poll a subset of a plurality of burst stream servers for unicast information in order to obtain a statistically accurate sampling of viewership information.

9. A method at a server, comprising:
tracking a number of times that a particular service channel is distributed from at least a network device that is used in an Internet Protocol Television (IPTV) network when a subscriber device initially tunes to the particular service channel; and
retrieving real time viewership information by polling the network device in the IPTV network to determine how many subscriber devices are tuned to each stream.

10. The method of claim 9, wherein the network device is a distributed multicast stream router and the distributed multicast stream router polls at pre-defined intervals.

11. The method of claim 9, wherein the method polls other backend systems to obtain information to map multicast stream information to IPTV system channels and to geographic information.

12. The method of claim 11, wherein the multicast stream information comprises IP addresses, the IPTV systems channels comprises call letter for the IPTV system channels, and the geographic information comprises video head-end office (VHO) membership.

13. The method of claim 9, comprising collecting EPG information or channel subscription information from a plurality of network sources by polling a backend service provisioning system or by polling a plurality STBs on the IPTV network.

14. The method of claim 9, comprising polling a multicast stream router at a lowest priority to reduce latency for television viewing.

15. The method of claim 9, comprising polling a subset of a plurality of distributed multicast stream routers in order to obtain a statistically accurate sampling of viewership information.

16. The method of claim 9 wherein the network device is a unicast stream router.

17. The method of claim 9, wherein the network device is a digital subscriber line access multiplexer (DSLAM) which is queried for multicast information.

18. A network device comprising a controller programmed to:
track a number of times that a particular service channel is distributed to a subscriber device from at least a network device selected from the group of a unicast stream server, a multicast stream router, or a digital subscriber line access multiplexer (DSLAM) which is used in an Internet Protocol Television (IPTV) network when the subscriber device initially tunes to the particular service channel; and
obtain real time viewership information by polling the network device in the IPTV network to determine how many subscriber devices are tuned to each service channel in the IPTV network.

19. The device of claim 18, wherein the service channel is a television channel or an audio channel and the subscriber devices is one of a set top box, a cellular phone, a personal computer or a laptop computer.

20. The device of claim 18, wherein the controller is programmed to obtain real-time viewership information.
